(19) United States
(12) Patent Application Publication
(10) Pub. No.: US 2003/0081696 A1
(43) Pub. Date: May 1, 2003

(54) System and method for estimating signal to noise ratio

(76) Inventors: In-Kyung Kim, N. Potomac, MD (US); Ludong Wang, Gaithersburg, MD (US)

Correspondence Address: Hughes Electronics Corporation, Patent Docket Administration, Bldg. 1, Mail Stop A109, P.O. Box 956, El Segundo, CA, 90245-0956, US

(21) Appl. No.: 10/118,756

(22) Filed: Apr. 9, 2002

Related U.S. Application Data
(60) Provisional application No. 60/345,868, filed on Oct. 29, 2001.

(51) Int. Cl. H04L 27/06

(52) U.S. Cl. 375/316; 375/340

(57) ABSTRACT

An improved method and system for estimating the signal to noise ratio in a communications system is provided. An FEC coded signal is received and demodulated. The signal is decoded, resulting in FEC coding gain. The decoded signal is re-encoded, and the re-encoded signal is used by the signal to noise ratio estimator to estimate the signal to noise ratio, thereby taking advantage of the FEC coding gain.

### FIELD OF THE INVENTION

The present invention is related to an improved system and method for estimating the Signal to Noise Ratio (SNR) in wireless communication systems, such as the GMR-1 system. More particularly, the present invention relates to a system and method for using forward error correction (FEC) coding gain to achieve a more accurate estimate of the SNR in a wireless communication system.

### BACKGROUND OF THE INVENTION

Satellite communication systems are used extensively to transmit voice and data traffic around the globe. Satellite signals are subject to various forms of interference including multipath, rain fades, and shadowing, among other types of interference. Therefore, a vital component of satellite systems, and in particular GMR-1 systems, is a signal to noise ratio (SNR) estimator at the satellite terminal on earth. The signal to noise ratio estimator produces an estimate of the signal to noise ratio, which is in turn used to determine the link quality. The SNR estimate is further used to direct link adaptation and power control. Thus, the efficiency of the satellite communication system is somewhat dependent on the accuracy of the SNR estimate.

Conventional systems used mainly for circuit-switched voice traffic use conventional SNR estimators that demonstrate severe bias at low signal to noise ratios. In other words, the accuracy of the SNR estimate obtained using conventional estimators declines as the actual SNR decreases.

The conventional signal to noise ratio estimator begins showing bias at Es/NO=8 dB, and has an error floor as high as Es/NO=3 dB. In voice systems, which operate at SNRs above 8 dB, this is acceptable. Furthermore, simple linearization techniques provide between 2 and 3 dB of dynamic range below the operating point of a voice system. However, performance at this level is unacceptable in newer, packet based data systems, which operate at lower SNRs. Packet data systems have operating points around Es/NO=5 dB, and therefore accurate estimation of the SNR should be available as low as Es/NO=2 dB. Accordingly, there is a present need for a more accurate SNR estimator.

### SUMMARY OF THE INVENTION

The above disadvantages are overcome and other advantages are realized with the present invention, in which forward error correction (FEC) feedback is employed at a satellite signal receiver to improve SNR estimation by taking advantage of the coding gain achieved by the FEC decoder at the receiver.

The invention is embodied in a signal to noise ratio estimator comprising a demodulator adapted to demodulate a received modulated signal. The estimator further includes a decoder adapted to decode the demodulated signal. An encoder is provided to re-encode the decoded signal. Finally, an estimator is provided which is adapted to calculate the signal to noise ratio estimate based on the demodulated signal and the re-encoded signal. The encoder is preferably a forward error correction (FEC) encoder. Furthermore, the signal is preferably re-encoded at the receiver using the same encoding method used prior to transmission.

The invention is further embodied in a method of estimating the signal to noise ratio in a communication system. The method comprises receiving an encoded modulated signal, demodulating the encoded modulated signal, decoding the encoded signal, and re-encoding the decoded signal. Furthermore, the method comprises estimating the signal to noise ratio based on the demodulated encoded signal and the re-encoded signal. The re-encoding step preferably utilizes a forward error correction (FEC) type of encoding. Furthermore, the re-encoding step preferably uses the same encoding method as was used to encode the original signal prior to transmission.

The invention is also embodied in a computer readable medium of instructions adapted to control a communications system. The computer readable medium of instructions comprises a first set of instructions adapted to control the communications system to receive an encoded modulated signal. A second set of instructions is provided which are adapted to control the communication system to demodulate the encoded modulated signal. A third set of instructions is adapted to control the system to decode the encoded signal. A fourth set of instructions is adapted to control the system to re-encoded the decoded signal. Finally, a fifth set of instructions is adapted to estimate the signal to noise ratio based on the demodulated encoded signal and the re-encoded signal. The third set of instructions is preferably adapted to control the system to decode the signal using forward error correction (FEC) decoding. The fourth set of instructions is preferably adapted to re-encode the decoded signal using the same encoding method used to encode the original signal prior to transmission.

### BRIEF DESCRIPTION OF THE DRAWINGS

The invention will be more readily understood with reference to the attached figures, in which:

FIG. 1 shows a communication system in which an SNR estimator in accordance with the present invention is employed;

FIG. 2 is a block diagram of a system including a conventional SNR estimator;

FIG. 3 is a block diagram of a system including a SNR estimator according to an embodiment of the present invention for use in a PRACH channel;

FIG. 4 is a block diagram of a system including a SNR estimator according to an embodiment of the present invention for use in a PNB or PDCH channel;

FIG. 5 illustrates an example of performance gains in the linear operating range of a SNR estimator in accordance with an embodiment of the present invention;

FIG. 6 illustrates an example of the decreased standard deviation in SNR estimation when using a SNR estimator in accordance with an embodiment of the present invention; and

FIG. 7 illustrates an example of the automatic code rate adaptability feature of a system in accordance with an embodiment of the present invention.

In the figures, it will be understood that like numerals refer to like features and structures.

### DETAILED DESCRIPTION OF THE INVENTION

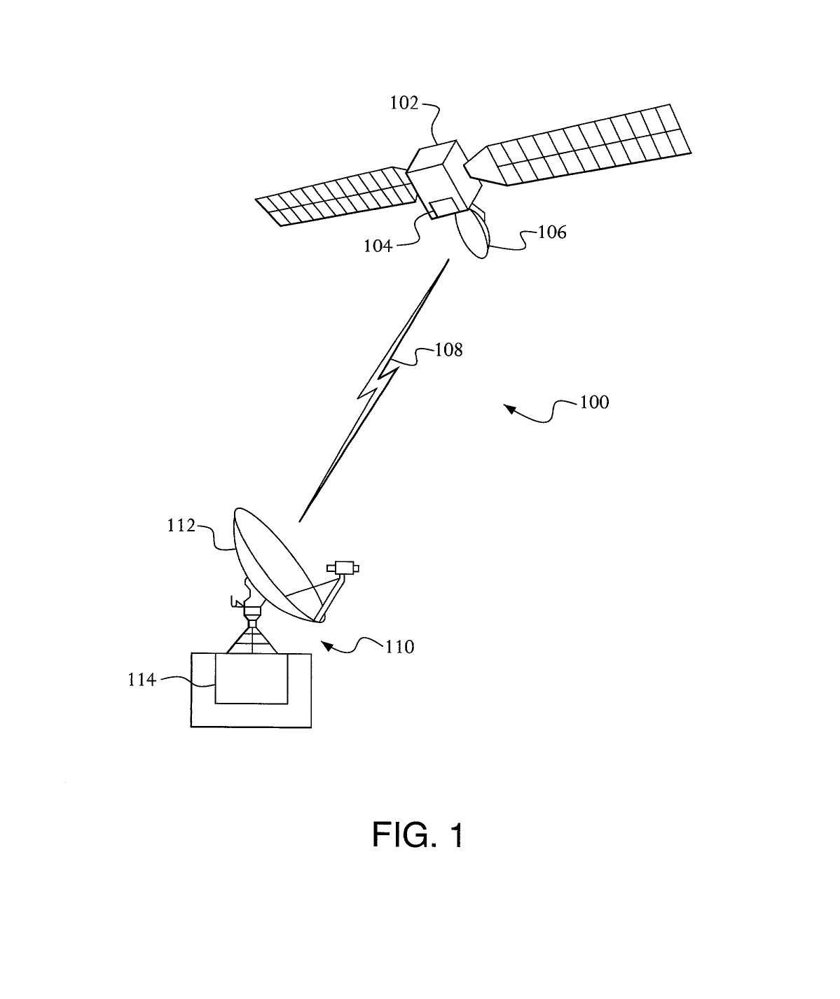

The invention will now be described with reference to the attached figures. FIG. 1 shows a communication system 100 in which the present invention is employed. The system includes a satellite 102 having a transmitter 104 and an antenna 106 for transmitting a signal 108 to a satellite terminal 110 on earth. The satellite terminal 110 includes a receiving antenna 112 and a receiver 114.

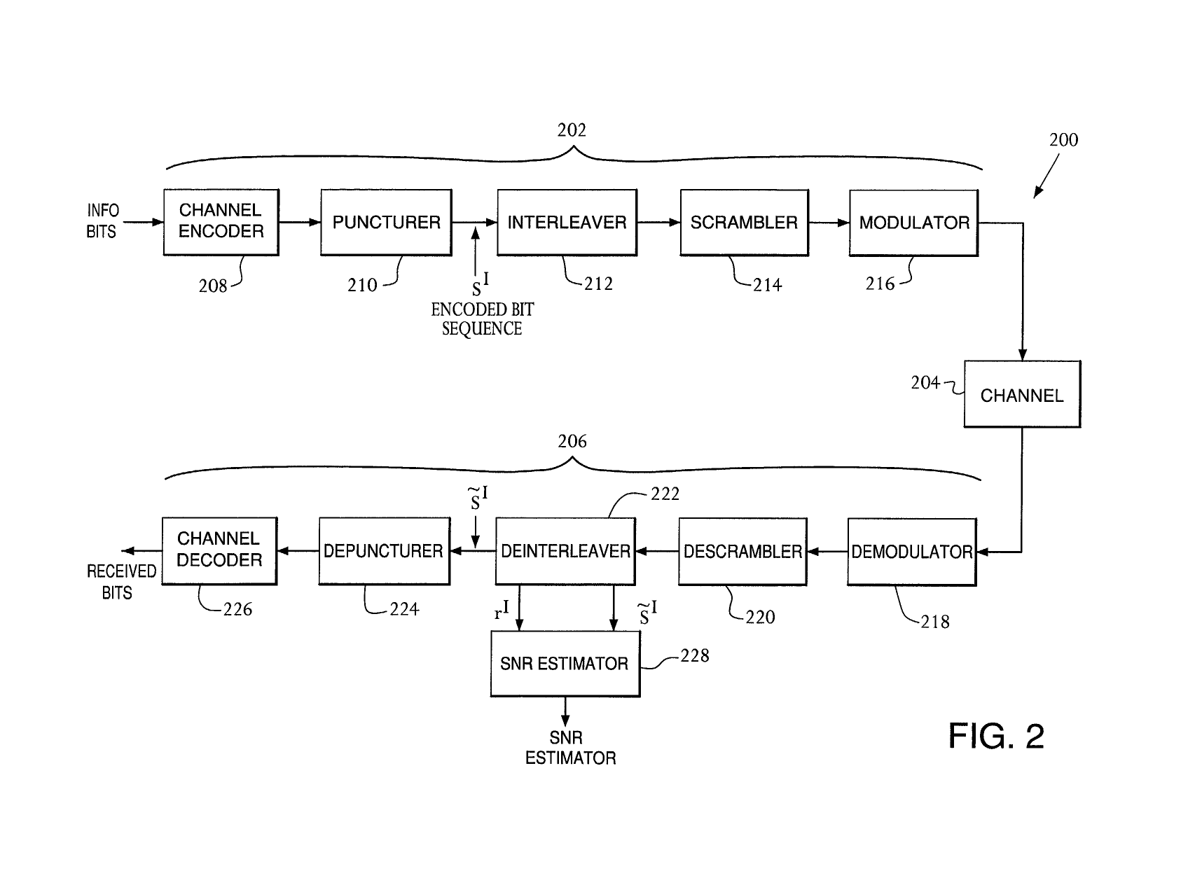

FIG. 2 is a block diagram of a communication system employing a conventional SNR estimator. Conventional SNR estimators use a method referred to as “blind error vector magnitude (EVM)” to estimate the signal to noise ratio. Blind EVM will be described in further detail below. It will be appreciated that the communication system shown in FIG. 2 is an exemplary communication system described for illustrative purposes, and components could be added, removed or modified and remain within the scope of this description. The system 200 illustrated in FIG. 2 includes a transmitter chain 202, a communications channel 204, and a receiver chain 206. The transmitter chain 202 corresponds with the transmitter 104 on board the satellite 102 in FIG. 1. Information bits which are to be transmitted are received by the channel encoder 208 and encoded. The encoder 208 can use convolutional coding, or block coding, or any other appropriate type of coding. The output of the channel encoder 208 are encoded bits which are sent to a puncturer 210.

The encoder typically produces more coded bits than information bits, and its output rate is described as a code rate. A typical code rate of ½ means that the encoded outputs two code bits for every information bit encoded. The puncturer 210 punctures the encoded bits, reducing the number of bits to be transmitted, and thereby increasing the efficiency of the transmission channel. The output of the puncturer 210 is the encoded bit sequence s^{I} which is to be transmitted. It is the encoded bit sequence s^{I} which serves as a reference for the signal to noise ratio estimator.

The encoded bit sequence may also be interleaved by interleaver 212, and scrambled by scrambler 214 before being received by modulator 216. As is understood in the art, the interleaver 214 and the scrambler 216 change the order of the bit sequence in a reversible manner. The interleaver advantageously reduces the negative effects of temporary signal fades or shadowing events (“burst errors”) by reversibly separating consecutive bits during transmission. Thus, if a burst error occurs during transmission (a number of consecutive bits are lost during transmission), after deinterleaving, the burst error bits will be separated in the deinterleaved bit sequence so that the errors are correctable by the decoder. The scrambler 216 scrambles the bits for security purposes, so that only receivers with appropriate descramblers will be able to receive and decode the signal.

Modulator 216 modulates the encoded, interleaved, scrambled bit sequence to the desired transmission frequency so that they can be transmitted on the physical channel 204. In a satellite system such as that shown in FIG. 1, the modulator 216 applies the modulated signal to the antenna 106 for transmission to the terrestrial satellite terminal 110.

The transmitted signal is received and processed by the receiver chain shown generally at 206. First, the signal is received and demodulated by demodulator 218. The resulting baseband signal is delivered to descrambler 220. Descrambler 220 reverses the scrambling process performed by scrambler 214 prior to transmission. The resulting unscrambled signal is then sent to Deinterleaver 222, which deinterleaves the interleaved signal.

In a communication system employing a conventional SNR estimator, as shown in FIG. 2, two types of outputs are generated at the output of Deinterleaver 222. The first output is a series of estimated encoded bits, \check{s}^{I}. The estimated encoded bit sequence \check{s}^{I} comprises hard decision bits, and are the receiver's best guess, based on the received signal, what bits were actually transmitted. The accuracy of this guess therefor affects the accuracy of the SNR estimate.

The second output is received sampled signal r^{I}. Received sampled signal r^{I} represents soft decision bits (sampled values). As will be described in further detail below, the SNR is estimated based on the difference between the received sampled signal r^{I}, and the estimated encoded bit sequence.

The estimated encoded bit sequence \check{s}^{I} is sent to depuncturer 224 to be depunctured. During depuncturing bits are added to the bit sequence by the depuncturer 224 in the locations where bits were removed by the pucturer 210 prior to transmission. Finally the depunctured encoded bit sequence is delivered to the channel decoder 226 to be decoded. The channel decoder is preferably a Viterbi decoder, as is known in the art, but could be any decoder which is matched to the channel encoder 208 used to encode the transmitted bit sequence. Furthermore, the channel decoder 226 is capable of correcting errors in the encoded bit sequence. The output of the channel decoder 226 is the sequence of received bits.

In order to estimate the SNR, both outputs of the deinterleaver 222 are sent to SNR estimator 228. SNR estimator compares the two signals to generate a SNR estimate, as will be described in further detail below. In a conventional system, as described with reference to FIG. 2, the estimated encoded bit sequence output from the deinterleaver 222 is compared to the received sampled signal. As will be described below, in a system according to an embodiment of the present invention, the received sample signal is compared to a more accurate estimate of the encoded but sequence than is obtained from the deinterleaver 222. Thus, a more accurate SNR estimate can be obtained.

In order to estimate the SNR in a received signal, the received signal is compared to the actual transmitted signal. Of course, in a practical communication system the actual transmitted bit sequence is not available to the receiver, so an estimate of the transmitted bit sequence must be made, and compared to the actual received signal samples.

Given the received signal samples r_{k,} k=0, 1, . . . , K−1, and transmitted bits sₖ, k=0, 1, . . . , K−1, the maximum likelihood estimate of the channel gain η is given by:

$$η = \frac{{\sum }_{k = 0}^{K - 1} {r}_{k} {s}_{k}}{{\sum }_{k = 0}^{K - 1} \vert {s}_{k} {\vert}^{2}}$$

Given η, rₖ and sₖ, the maximum likelihood estimate of the noise variance α² is:

$${α}^{2} = \frac{1}{K} {\sum }_{k = 0}^{K - 1} \vert {r}_{k} - η {s}_{k} {\vert}^{2}$$

Given η and sₖ, the average signal energy μ² is given by:

$${μ}^{2} = \frac{1}{K} {η}^{2} {\sum }_{k = 0}^{K - 1} \vert {s}_{k} {\vert}^{2}$$

Thus, taking the ratio of the signal energy μ² and the noise energy α², the SNR estimate is given by:

$${γ}_{d B} = 10 {log}_{10} ( \frac{{μ}^{2}}{{α}^{2}} ) = 10 {log}_{10} ( \frac{{η}^{2} {\sum }_{k = 0}^{K - 1} \vert {s}_{k} {\vert}^{2}}{{\sum }_{k = 0}^{K - 1} \vert {r}_{k} - η {s}_{k} {\vert}^{2}} )$$

Ideally, the actual bits transmitted would be chosen as the values for sₖ, but in most cases the actual values are not known. Only the received bits, which may contain errors, are known. In a GMR-1 system for transmitting data, there are packet random access channels (PRACH) and packet data traffic channels (PDCH). PRACH channels are used to establish PDCH channels, and contain code words (CWs) and unique words (UWs) which are known bit patterns. As a result, the SNR estimator can take advantage of known bit patterns in the transmitted bit sequence (in addition to unknown information bits) to more accurately estimate the SNR. However, for PDCHs containing information bits, the number of known bit patterns is small, thus unknown data bits are used for SNR estimation, and the accuracy of the SNR estimate is dependent on the accuracy of the estimate of the transmitted bit sequence. The equations used to calculate the SNR estimate for PRACH and PDCH cases will be described in further detail below.

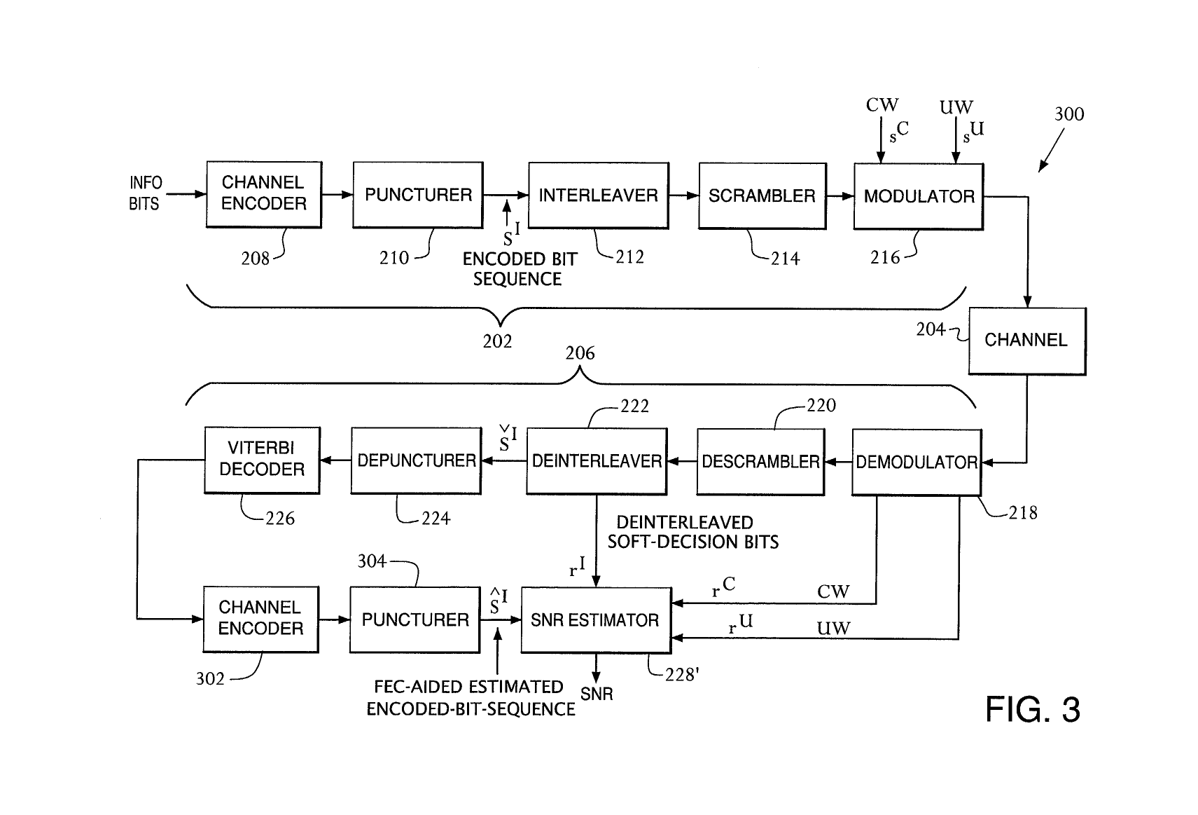

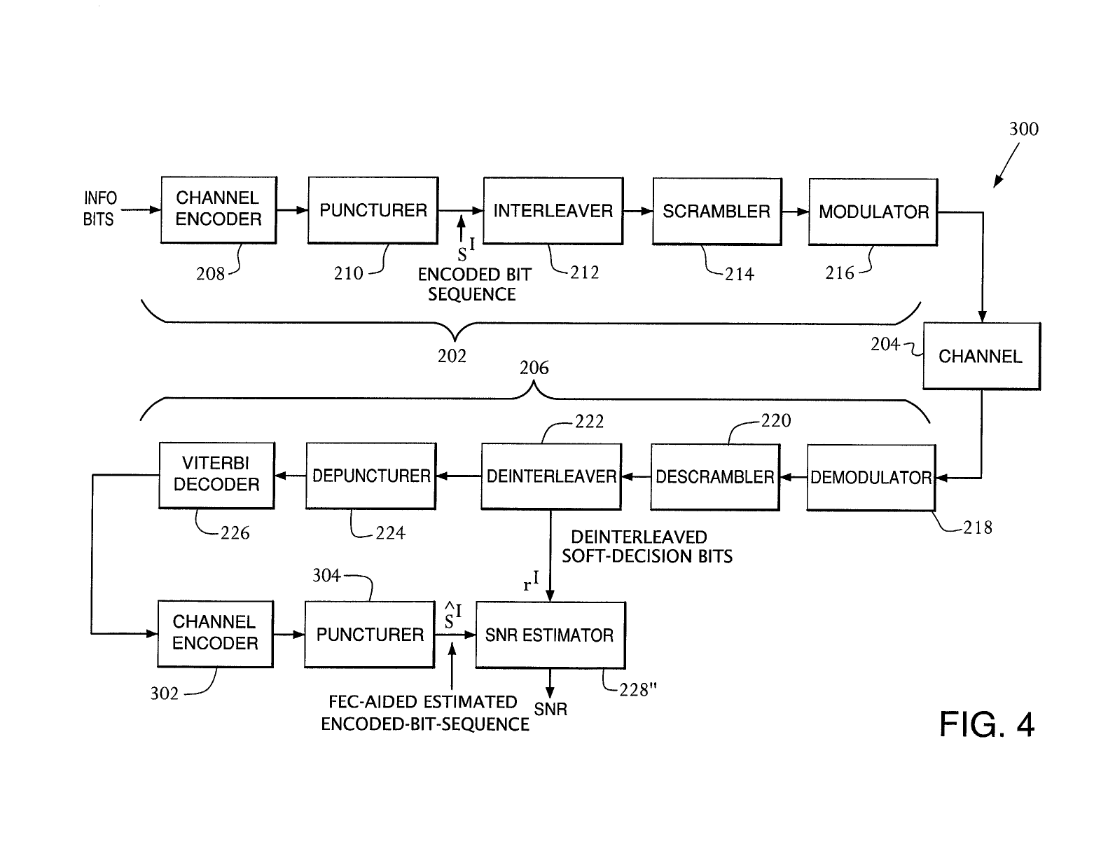

A system in accordance with the present invention will now be described with reference to FIGS. 3 and 4, which are block diagrams of a system employing a SNR estimator according to an embodiment of the present invention, for PRACH and PDCH channels, respectively.

FIG. 3 is a block diagram illustrating a system employing a SNR estimator for use with PRACH data. The transmitter chain 202 is essentially unchanged from the system described in connection with FIG. 2. However, as shown, when PRACH data is being transmitted, code word CW and unique word UW bit sequences are modulated and transmitted at modulator 216 along with the information bits s^{I}. Thus, the output of modulator 216 is s^{I}+s^{C}+sr^{U}.

After being transmitted through the channel 204, transmitted bits s^{I}+s^{C}+s^{U} are received as r^{I}+r^{C}+r^{U}, which include the effects of noise and other interference caused during transmission. Demodulator 218 demodulates the received bits to baseband. Received signal samples corresponding to the CW (r^{C}) and UW (r^{U}) are forwarded to the SNR estimator for processing. Next, the r^{I} bit sequence is forwarded by demodulator 218 to descrambler 220 and deinterleaver 222 to produce encoded signal samples which have been descrambled and deinterleaved. The descrambled, deinterleaved signal samples r^{I} are sent to SNR estimator 228′ for use in estimating the SNR.

Hard decision bits \check{s}^{I} are sent to pucturer 224 to be depunctured, and to the channel decoder 226 to be decoded. The decoder, as discussed above, is preferably a Viterbi decoder, and must be capable of correcting errors in the estimated bit sequence \check{s}^{I}.

The decoded bit sequence output from the channel decoder 226 corresponds to the information bits originally intended to be transmitted. The bit sequence produced by the channel decoder 226 has improved accuracy relative to the estimated coded bit sequence \check{s}^{I} due to coding gain achieved by channel decoder 226.

The bit sequence output from the channel decoder 226, while being an improved estimate of the transmitted bit sequence due to coding gain, is not in a form that is usable by the SNR estimator. As a result of the depuncturing and decoding operations, the number of bits in the bit sequence output from the decoder 226 is smaller than the number of soft decision signal samples output from deinterleaver 222. Therefore, in order to take advantage of the coding gain achieved by decoder 226, the output bits are re-encoded using channel encoder 302, and re-punctured using pucturer 304, generating bit sequence ŝ^{I} which is a FEC-aided estimated encoded bit sequence.

FEC-aided estimated encoded bit sequence ŝ^{I} is received by SNR estimator 228′. As shown, SNR estimator also receives signal samples r^{I}, corresponding to the estimated bit sequence ŝ^{I}, and signal samples r^{C} and r^{W}, corresponding to transmitted code words (CWs) and unique words (UWs) respectively. The SNR estimator 228′ estimates the signal to noise ratio based on the received signal samples as well as the FEC-aided estimated encoded bit sequence. Because the actual bit sequences for the CW and UW are known, an estimate of the transmitted CW and UW are not necessary. Thus, the SNR estimator uses the following equation to estimate the signal to noise ratio:

$${γ}_{d B} = 10 {log}_{10} [ \frac{{η}^{2} ( {\sum }_{k = 0}^{105} \vert {\hat{s}}_{k}^{I} {\vert}^{2} + {\sum }_{k = 0}^{71} \vert {s}_{k}^{C} {\vert}^{2} + {\sum }_{k = 0}^{23} \vert {s}_{k}^{U} {\vert}^{2} )}{{\sum }_{k = 0}^{105} \vert {r}_{k}^{I} - η {\hat{s}}_{k}^{I} {\vert}^{2} + {\sum }_{k = 0}^{71} \vert {r}_{k}^{C} - η {s}_{k}^{C} {\vert}^{2} + {\sum }_{k = 0}^{23} \vert {r}_{k}^{U} - η {s}_{k}^{U} {\vert}^{2}} ] ,$$

where the channel gain, η, is given by:

$$η = \frac{{\sum }_{k = 0}^{105} {r}_{k}^{I} {\hat{s}}_{k}^{I} + {\sum }_{k = 0}^{71} {r}_{k}^{C} {s}_{k}^{C} + {\sum }_{k = 0}^{23} {r}_{k}^{U} {s}_{k}^{U}}{{\sum }_{k = 0}^{105} \vert {\hat{s}}_{k}^{I} {\vert}^{2} + {\sum }_{k = 0}^{71} \vert {s}_{k}^{C} {\vert}^{2} + {\sum }_{k = 0}^{23} \vert {s}_{k}^{U} {\vert}^{2}}$$

It will be appreciated that in the above two equations, there are three terms in each numerator and denominator. One term in each corresponds to the unknown estimated information bits, ŝ^{I}. A second term in each corresponds to CW bits, s^{C}. A third term in each corresponds to UW bits, s^{U}. Thus, the SNR estimator 228′, shown in FIG. 3 takes advantage of the known bit sequences s^{C} and s^{U}, and compares them to the received signal samples corresponding to the CW and UW portions of the received signal. The SNR estimator 228′ also compares the received signal samples corresponding to encoded information bits r^{I} to the FEC-aided estimated encoded bit sequence ŝ^{I}.

FIG. 4 illustrates a SNR estimator in accordance with an embodiment of the present invention, employed in a receiver on a PNB or PDCH channel. In a data channel, unlike a PRACH channel, the number of known bits is small compared to the total number of unknown information bits. Thus, the SNR estimator 228″ shown in FIG. 4 has only two inputs. The first is the de-interleaved soft decision bits (signal samples) rᵢ, and the second is the FEC-aided estimated encoded bit sequence ŝᵢ.

Thus, the equation used by the SNR estimator 228″ is as follows:

$${γ}_{d B} = 10 {log}_{10} ( \frac{{η}^{2} {\sum }_{i = 0}^{210 m - 49} \vert {\hat{s}}_{i} {\vert}^{2}}{{\sum }_{i = 0}^{210 m - 49} \vert {r}_{i} - η {\hat{s}}_{i} {\vert}^{2}} )$$

where channel gain η is given by:

$$η = \frac{{\sum }_{i = 0}^{210 m - 49} {r}_{i} {\hat{s}}_{i}}{{\sum }_{i = 0}^{210 m - 49} \vert {\hat{s}}_{i} {\vert}^{2}}$$

Performance

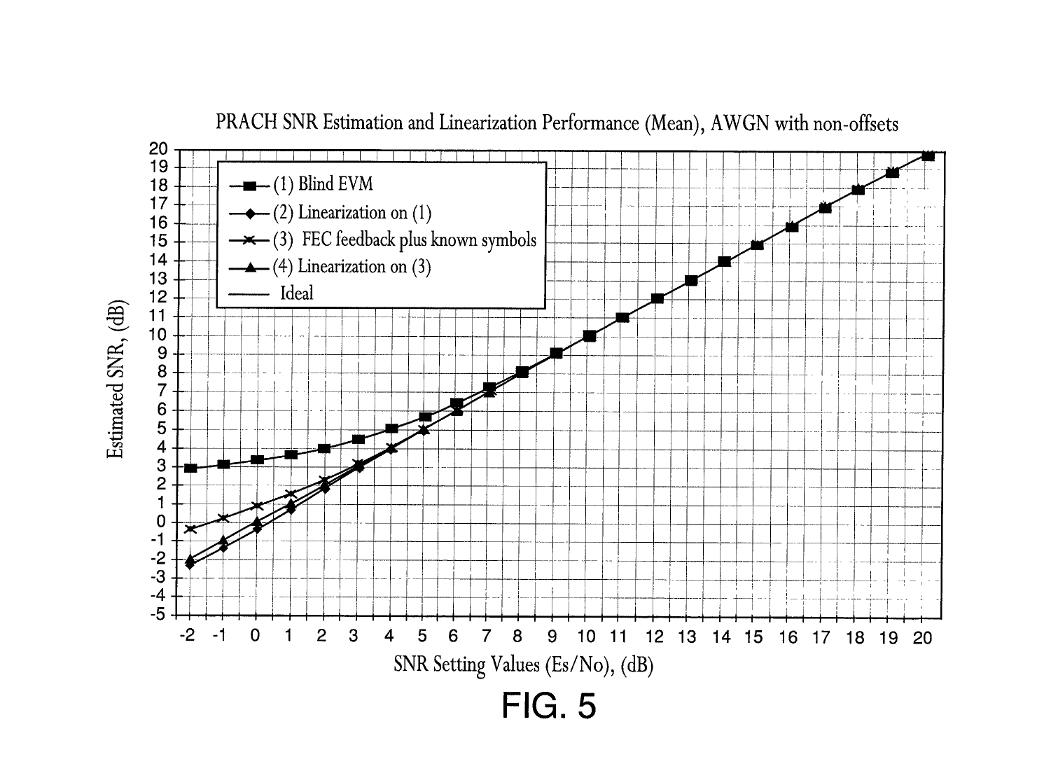

FIG. 5 illustrates the performance gains realized by using FEC feedback in estimating the SNR, in accordance with an embodiment of the present invention as disclosed above. The conventional “blind EVM” method of estimation results in bias beginning around 8 dB, with an error floor near 3 dB. As shown, utilizing FEC feedback results in a larger linear range, with bias beginning near 3 dB, and a much lower error floor. Also shown in FIG. 5 are the beneficial effects of linearization on both blind EVM and FEC feedback. The results shown are for an SNR estimator in a PRACH channel, thus known CW and UW symbols are included in the SNR estimate calculation as described above.

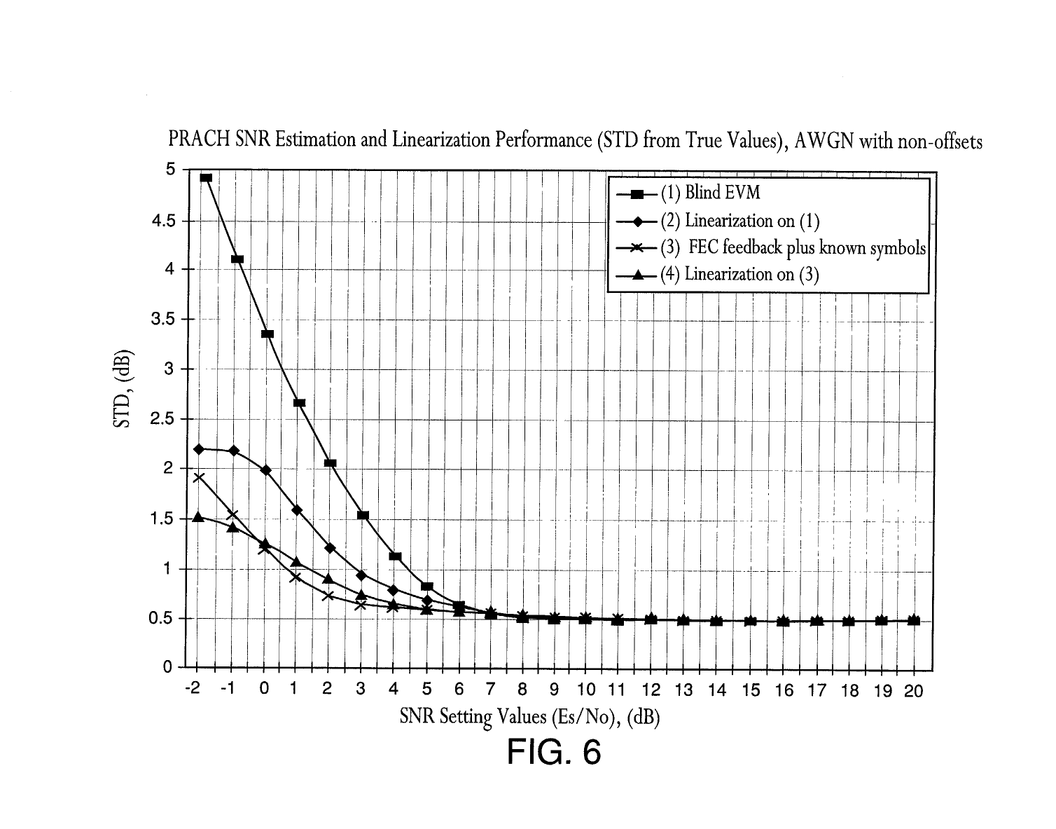

FIG. 6 illustrates a performance comparison of standard deviation between a conventional blind EVM system and a FEC-aided system in accordance with an embodiment of the present invention as described above. Also shown are both blind EVM and FEC-aided systems using linearization. As shown, the standard deviation (STD) is significantly reduced in the FEC-aided system.

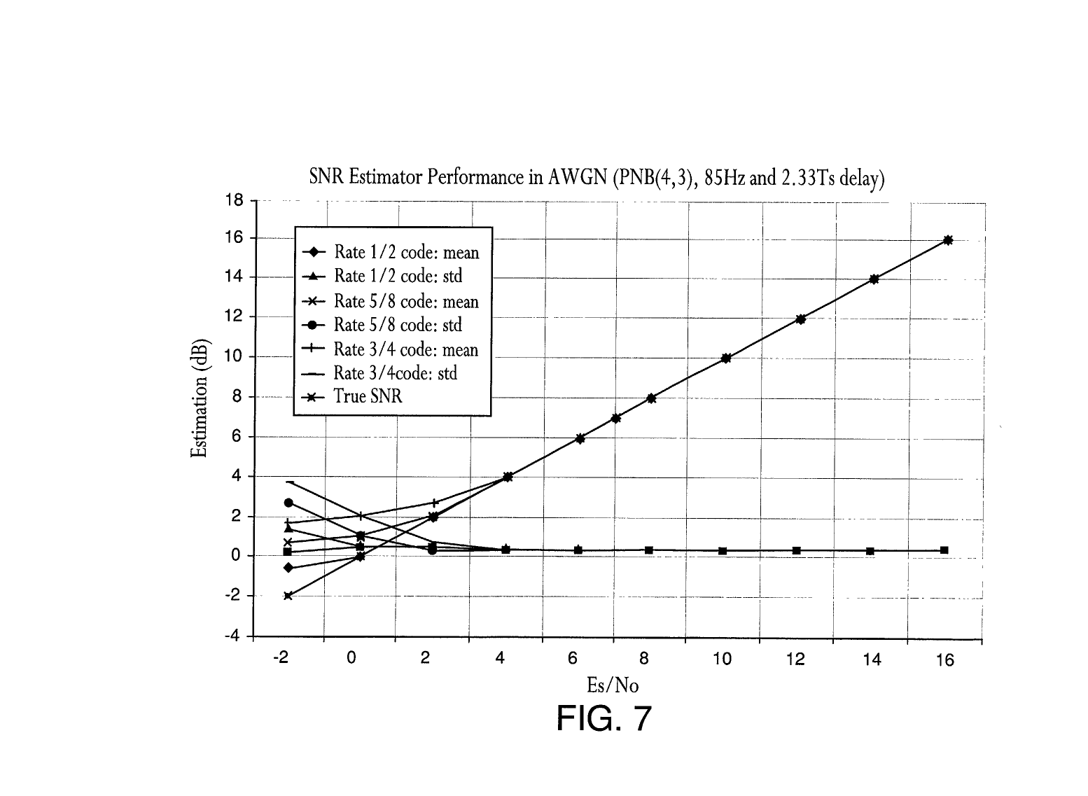

FIG. 7 illustrates the performance of FEC-aided systems for various code rates. Because the system takes advantage of coding gain to obtain a better estimate, the type of coding affects the amount of gain achieved. Thus, a system in accordance with the present invention demonstrates code rate adaptability. In other words, use of a higher code rate results in even lower operating points, and increased linear ranges for accurate SNR estimation. This is a particularly advantageous feature of the present invention, because a code rate may be selected based on environmental conditions, and the system adapts its operating point accordingly. Higher code rates allow for even lower operating points.

While the invention herein disclosed has been described by means of specific embodiments and applications thereof, numerous modifications and variations could be made thereto by those skilled in the art without departing from the scope of the invention set forth in the claims.

What is claimed is:

1. A signal to noise ratio estimator for a communication system comprising:
a demodulator, adapted to demodulate a received modulated signal,
a decoder, adapted to decode the demodulated signal,
an encoder, adapted to re-encode the decoded signal, and
a signal to noise ratio estimator, adapted to calculate the signal to noise ratio based on the demodulated signal and the re-encoded signal.

2. The signal to noise ratio estimator of claim 1, wherein the encoder is a forward error correction encoder.

3. The signal to noise ratio estimator of claim 1, wherein the encoder uses the same encoding technique as a transmitter encoder which encoded the received modulated signal.

4. A method of estimating the signal to noise ration in a communications system comprising the steps of:
receiving an encoded modulated signal,
demodulating the encoded modulated signal,
decoding the encoded signal,
re-encoding the signal, and
calculating the signal to noise ratio based on the demodulated signal and the re-encoded signal.

5. The method of claim 4, wherein the step of re-encoding the signal includes using a forward error correction encoder.

6. The method of claim 4, wherein the step of re-encoding the signal, includes using the same encoding technique as a transmitter encoder that generated the encoded modulated signal.

7. A computer readable medium of instructions adapted to control a communications system comprising:
a first set of instruction adapted to control the communications system to receive an encoded modulated signal,
a second set of instructions adapted to control the communications system to demodulate the encoded modulated signal,
a third set of instructions adapted to control the communications system to decode the encoded signal,
a fourth set of instructions adapted to control the communications system to re-encode the decoded signal, and
a fifth set of instructions adapted to determine the signal to noise ratio based on the demodulated encoded signal and the re-encoded signal.

8. The computer readable medium of instructions of claim 7, wherein the third set of instructions is adapted to decode the encoded signal using a forward error correction decoder.

9. The computer readable medium of instructions of claim 7, wherein the fourth set of instructions is adapted to re-encode the decoded signal using the same encoding technique as a transmitter encoder that generated the encoded modulated signal.
